(19) United States
(12) Patent Application Publication
(10) Pub. No.: US 2013/0319832 A1
(43) Pub. Date: Dec. 5, 2013

(54) TOUCH PANEL

(71) Applicant: SHIH HUA TECHNOLOGY LTD., Zhubei City (TW)

(72) Inventors: CHIH-HAN CHAO, Hsinchu (TW); PO-SHENG SHIH, Hsinchu (TW); JIA-SHYONG CHENG, Hsinchu (TW)

(73) Assignee: SHIH HUA TECHNOLOGY LTD., Zhubei City (TW)

(21) Appl. No.: 13/730,813

(22) Filed: Dec. 28, 2012

(30) Foreign Application Priority Data
May 29, 2012 (TW) 101119226

(51) Int. Cl. H01H 1/027

(52) U.S. Cl. CPC H01H 1/027
USPC 200/263

(57) ABSTRACT

A touch panel includes a first electrode plate and a second electrode plate. The first electrode plate includes a first substrate and a first conductive layer. The first conductive layer is located on a surface of the first substrate. The first conductive layer is a carbon nanotube layer. The second electrode plate includes a second substrate and a second conductive layer. The second conductive layer is located on a surface of the second substrate. The second conductive layer is opposite to and spaced from the first conductive layer. The second conductive layer is a metal conductive layer.

### CROSS-REFERENCE TO RELATED APPLICATIONS

This application claims all benefits accruing under 35 U.S.C. §119 from Taiwan Patent Application No. 101119226, filed on 2012 May 29, in the Taiwan Intellectual Property Office, the disclosure of which is incorporated herein by reference.

### BACKGROUND

1. Technical Field

The disclosure relates to touch panels and, particularly, to a carbon nanotube-based touch panel.

2. Description of Related Art

Various electronic apparatuses such as computers, mobile phones, household electrical appliances, toys and the like are equipped with optically transparent touch panels applied over display devices. The electronic apparatus is operated when contact is made with the touch panel corresponding to elements appearing on the display device. A demand thus exists for such touch panels to maximize visibility and reliability in operation.

From the property of light transmittance, touch panels can be transparent or opaque. Printed circuit boards (PCB) are used in opaque touch panels. However, using the PCB in small household electrical appliances, toys and keyboard equipped with touch panels will increase cost. In addition, a larger size PCB has a great thickness and weight.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a touch panel in one embodiment.

FIG. 2 is a transverse cross-sectional view of the touch panel of FIG. 1 assembled.

FIG. 3 shows a Scanning Electron Microscope (SEM) image of a carbon nanotube layer of FIG. 1.

FIG. 4 is a transverse cross-sectional view of a touch panel in another embodiment.

FIG. 5 is a vertical view of a first electrode plate and a second electrode plate of the touch panel of FIG. 4.

FIG. 6 is a transverse cross-sectional view of a touch panel in another embodiment.

FIG. 7 is a vertical view of a first electrode plate of the touch panel of FIG. 6.

FIG. 8 is a transverse cross-sectional view of a touch panel in another embodiment.

FIG. 9 is a vertical view of a second electrode plate of the touch panel of FIG. 8.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

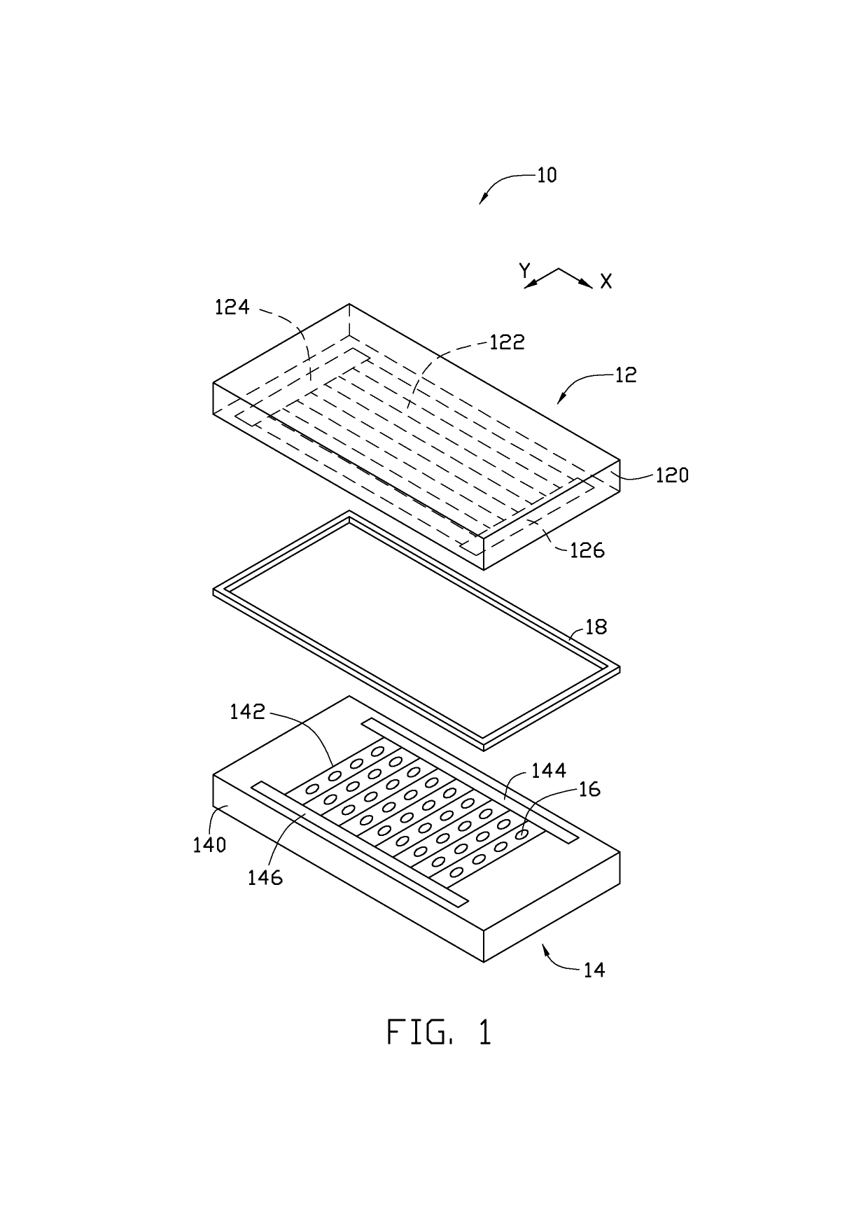

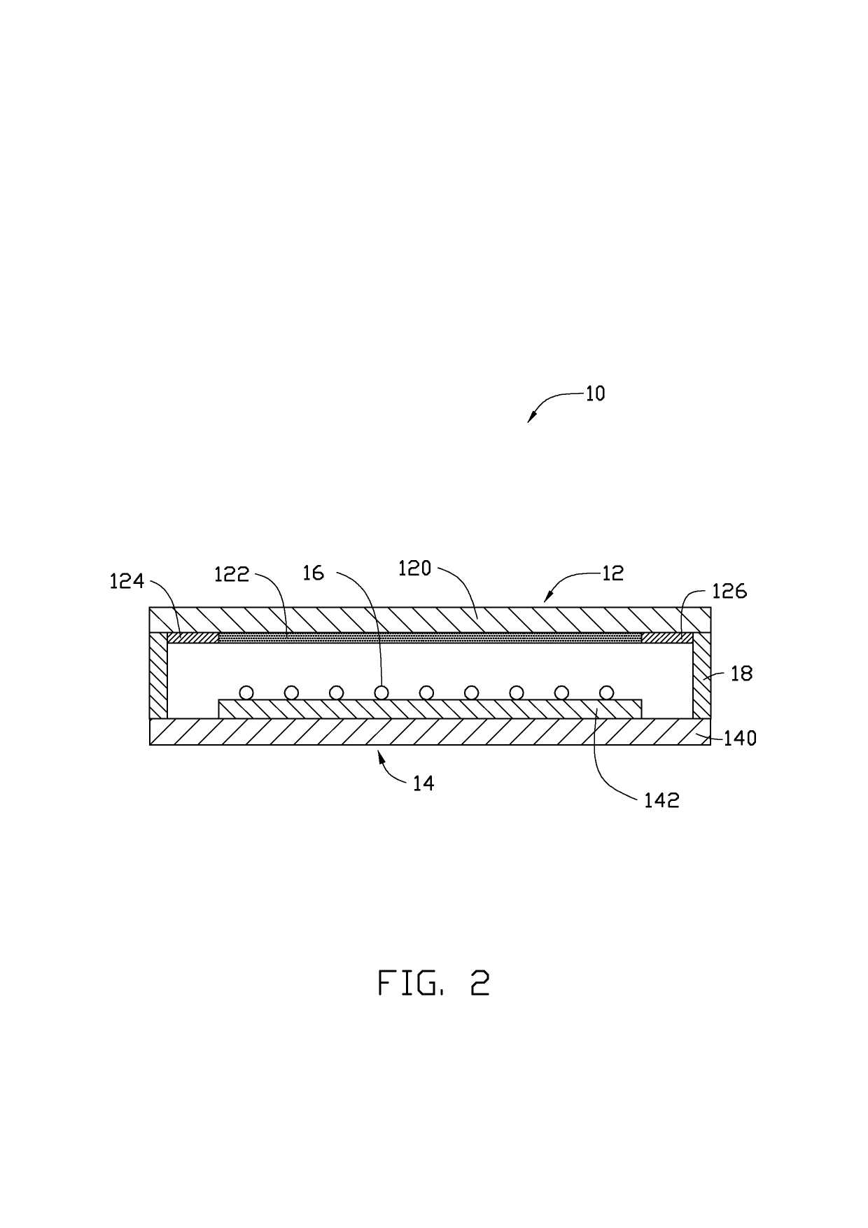

Referring to FIG. 1 and FIG. 2, one embodiment of a touch panel 10 includes a first electrode plate 12, a second electrode plate 14, a plurality of dot spacers 16, and an insulating frame 18.

The first electrode plate 12 is opposite to and spaced from the second electrode plate 14. The dot spacers 16 and the insulating frame 18 are located between the first electrode plate 12 and the second electrode plate 14. The insulating frame 18 is located on a periphery of the first electrode plate 12 and the second electrode plate 14.

In detail, the first electrode plate 12 includes a first substrate 120, a first conductive layer 122, a first electrode 124, and a second electrode 126. The first substrate 120 includes a first surface. The first conductive layer 122, the first electrode 124, and the second electrode 126 are located on the first surface of the first substrate 120. The first conductive layer 122 and the first electrode 124 are spaced from each other. The first electrode 124 and the second electrode 126 are located on opposite sides of the first conductive layer 122. The first electrode 124 and the second electrode 126 extend substantially along a second direction indicated by a Y axis shown in FIG. 1. The first electrode 124 and the second electrode 126 are electrically connected to the first conductive layer 122.

The second electrode plate 14 includes a second substrate 140, a second conductive layer 142, a third electrode 144, and a fourth electrode 146. The second substrate 140 includes a second surface, which can be substantially flat. The second surface is opposite to and spaced from the first electrode plate 12. The second conductive layer 142, the third electrode 144, and the fourth electrode 146 are located on the second surface of the second substrate 120. The second conductive layer 142 and the third electrode 144 are spaced from each other. The third electrode 144 and the fourth electrode 146 are located on opposite sides of the second conductive layer 142. The third electrode 144 and the fourth electrode 146 extend substantially along a first direction indicated by an X axis shown in FIG. 1. The third electrode 144 and the fourth electrode 146 are electrically connected to the second conductive layer 142.

The second conductive layer 142, the third electrode 144, and the fourth electrode 146 are opposite to and spaced from the first conductive layer 122, the first electrode 124, and the second electrode 126. The distance between the first conductive layer 122 and the second conductive layer 142 can range from about 2 micrometers to about 10 micrometers. The X axis can cross the Y axis. In one embodiment, the X axis is substantially perpendicular to the Y axis, such that the first electrode 124 and the second electrode 126 are substantially orthogonal to the third electrode 144 and the fourth electrode 146.

The first substrate 120 and the second substrate 140 are flexible films or flexible plates made of polymer, resin, or any other flexible material. The first substrate 120 and the second substrate 140 can be transparent or opaque. The first substrate 120 and the second substrate 140 are made of glass, diamond, quartz, plastic, or any other suitable material. The first substrate 120 and the second substrate 140 can be made of a flexible material. The flexible material can be polycarbonate (PC), polymethyl methacrylate acrylic (PMMA), polyethylene terephthalate (PET), polyethersulfone (PES), polyvinyl chloride (PVC), benzocyclobutenes (BCB), polyesters, acrylic resins, acrylonitrile butadiene styrene (ABS), polyamide (PA), or combination thereof. The thickness of each of the first substrate 120 and the second substrate 140 can range from about 1 millimeter to about 1 centimeter. In one embodiment, the first substrate 120 and the second substrate 140 are made of PET, and each of the first substrate 120 and the second substrate 140 has a thickness of about 0.5 millimeters.

The first electrode 124, the second electrode 126, the third electrode 144, and the fourth electrode 146 can be made of electrically conductive materials, such as metal or carbon nanotubes. In one embodiment, the first electrode 124, the second electrode 126, the third electrode 144, and the fourth electrode 146 are made of silver.

The first conductive layer 122 can be or can include a carbon nanotube layer formed of a plurality of carbon nanotubes. The thickness of the carbon nanotube layer can range about 0.5 nanometers to about 200 micrometers. The thickness of the carbon nanotube layer can be selected according to need. In one embodiment, the thickness of the carbon nanotube layer ranges about 100 nanometers to about 200 nanometers.

Because the carbon nanotubes provide superior strength, flexibility, and uniform conductivity to the carbon nanotube film, the touch panel 10 using the carbon nanotube layer is durable, flexible, and highly conductive.

The majority of the carbon nanotubes of the carbon nanotube layer are arranged substantially along the same direction. The carbon nanotube layer can comprise at least one carbon nanotube film. The carbon nanotube layer has good light transparency. The light transparency of a single carbon nanotube film can be greater than 85%. In one embodiment, the carbon nanotube layer can comprise at least two stacked carbon nanotube films or a plurality of carbon nanotube films contiguously located side by side, and carbon nanotubes of the carbon nanotube films are arranged to be substantially oriented along the same direction.

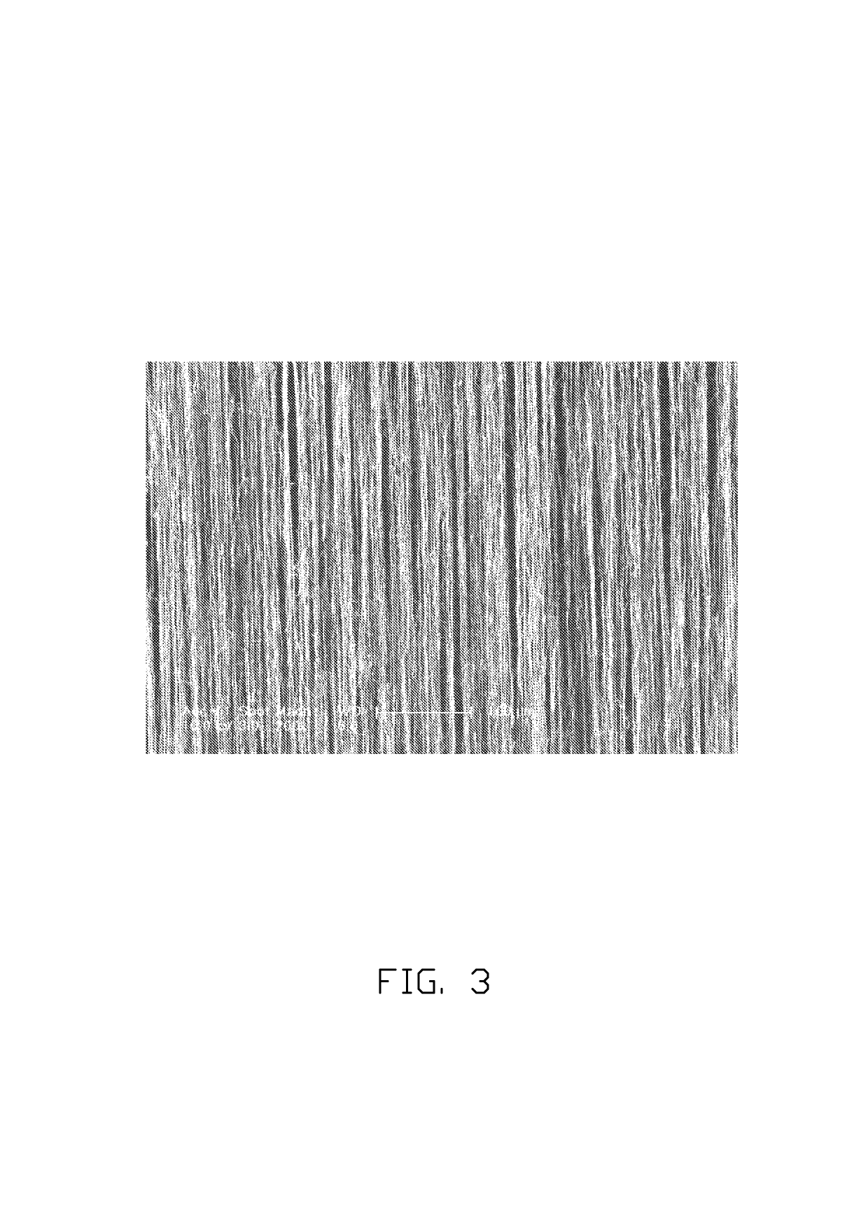

FIG. 3 shows a carbon nanotube film. The carbon nanotube film includes a plurality of carbon nanotubes that can be arranged substantially parallel to a surface of the carbon nanotube film. A large number of the carbon nanotubes of the carbon nanotube film can be oriented along a preferred orientation, meaning that a large number of the carbon nanotubes of the carbon nanotube film are arranged substantially along the same direction. An end of one carbon nanotube of the large number of the carbon nanotubes is joined to another end of an adjacent one of the large number of the carbon nanotubes arranged substantially along the same direction, by van der Waals attractive force. A small number of the carbon nanotubes are randomly arranged in the carbon nanotube film, and has a small if not negligible effect on the larger number of the carbon nanotubes of the carbon nanotube film arranged substantially along the same direction. The carbon nanotube film is capable of forming a freestanding structure. The term “freestanding structure” can be defined as a structure that does not have to be supported by a substrate. For example, a freestanding structure can sustain its weight when hoisted by a portion thereof without any significant damage to its structural integrity. So, if the carbon nanotube film is placed between two separate supporters, a portion of the carbon nanotube film, not in contact with the two supporters, would be suspended between the two supporters and yet maintain film structural integrity. The freestanding structure of the carbon nanotube film is realized by the successive carbon nanotubes joined end to end by van der Waals attractive force.

Some variation can occur in the orientation of the carbon nanotubes of the carbon nanotube film as can be seen in FIG. 3. Microscopically, the carbon nanotubes oriented substantially along the same direction may not be perfectly aligned in a straight line, and some curve portions may exist. Some carbon nanotubes located substantially side by side and oriented along the same direction may be in contact with each other can not be excluded.

The carbon nanotubes of the carbon nanotube layer can be single-walled, double-walled, and/or multi-walled carbon nanotubes. The diameters of the single-walled carbon nanotubes can range from about 0.5 nanometers to about 50 nanometers. The diameters of the double-walled carbon nanotubes can range from about 1 nanometer to about 50 nanometers. The diameters of the multi-walled carbon nanotubes can range from about 1.5 nanometers to about 50 nanometers. The lengths of the carbon nanotubes can range from about 200 micrometers to about 900 micrometers.

The carbon nanotube layer can have different resistivity along the extending direction of carbon nanotubes and other directions. The ratio of the resistivity of the carbon nanotube layer along the extending direction of the carbon nanotubes and the resistivity of the carbon nanotube layer along other directions can be less than or equal to 1:2.

In one embodiment, the first conductive layer 122 is a carbon nanotube film. The light transparency of the first conductive layer 122 can be about 90%. The carbon nanotubes of the carbon nanotube film are arranged substantially along the X axis. The resistivity of the carbon nanotube film along the X axis is less than the resistivity of the carbon nanotube film along the Y axis. The first electrode 124 and the second electrode 126 are located along the X axis on the first conductive layer 122 and extend substantially along the Y axis.

The first conductive layer 122 can be disposed on the first substrate 120 via adhesive, or can be directly attached to the first substrate 120 because the carbon nanotube layer has a strong adhesive property.

The second conductive layer 142 can be an opaque conductive layer. The term “opaque” is that the light transmittance of the second conductive layer 142 under visible light is less than or equal to 50%. The touch panel 10 with the opaque second conductive layer 142 can be applied in opaque equipments, for example, a keyboard, remote controller, and tablet.

The material of the second conductive layer 142 can be metal. For example, the material of the second conductive layer 142 can be aluminum, silver, copper, iron, cobalt, nickel, or alloys thereof. The material and the thickness of the second conductive layer 142 can be selected according to need. The thickness of the second conductive layer 142 can be greater than 10 nanometers. For example, the thickness of the second conductive layer 142 can be about 50 nanometers, about 100 nanometers, about 250 nanometers, about 500 nanometers, about 1 micrometer, about 5 micrometers, about 10 micrometers, about 20 micrometers, or about 100 micrometers. In one embodiment, the thickness of the second conductive layer 142 can be greater than or equal to 50 nanometers, and less than or equal to 30 micrometers. In one embodiment, the second conductive layer 142 is made of silver, the thickness of the second conductive layer 142 ranges from about 4 micrometers to about 25 micrometers. In one embodiment, the thickness of the second conductive layer 142 is about 5 micrometers.

The second conductive layer 142 can be formed on the second substrate 140 via spraying, evaporating, sputtering, or printing. In one embodiment, the second conductive layer 142 is formed on the second substrate 140 via spraying.

The dot spacers 16 can be located on the first conductive layer 122 or the second conductive layer 142. The dot spacers 16 are spaced from each other. In one embodiment, the dot spacers 16 are located on the second conductive layer 142. The insulating frame 18 is located between the first electrode plate 12 and the second electrode plate 14. The insulating frame 18 and the dot spacers 16 can be made of insulating resin or any other suitable insulating material. Insulation between the first electrode plate 12 and the second electrode plate 14 is also provided by the insulating frame 18 and the dot spacers 16. The dot spacers 16 are optional, particularly when the touch panel 10 is relatively small. They serve as supports given the size of the span and the strength of the first electrode plate 12.

In operation of the touch panel 10, a voltage is applied to the first electrode plate 12 and the second electrode plate 14. Contact can be made with the first electrode plate 12 or the second electrode plate 14 by a tool such as a finger, pen, or the like. The resulting deformation of the first electrode plate 12 or the second electrode plate 14 causes a connection between the first conductive layer 122 and the second conduction layer 142. Changes in voltages in the Y axis of the first conductive layer 122 and the X axis of the second conductive layer 142 are detected to calculate the position of the deformation.

In one embodiment, the first electrode 124 and the second electrode 126 can be located on the second electrode plate 14 rather than the first electrode plate 12. In detail, the first electrode 124 and the second electrode 126 can be spaced from each other and located on opposite sides of the second conductive layer 142 along the X axis. The third electrode 144 and the fourth electrode 146 can be spaced from each other and located on opposite sides of the second conductive layer 142 along the Y axis. The first electrode 124, the second electrode 126, the third electrode 144, and the fourth electrode 146 are electrically connected with the second conductive layer 142. The first direction can be substantially perpendicular to the second direction.

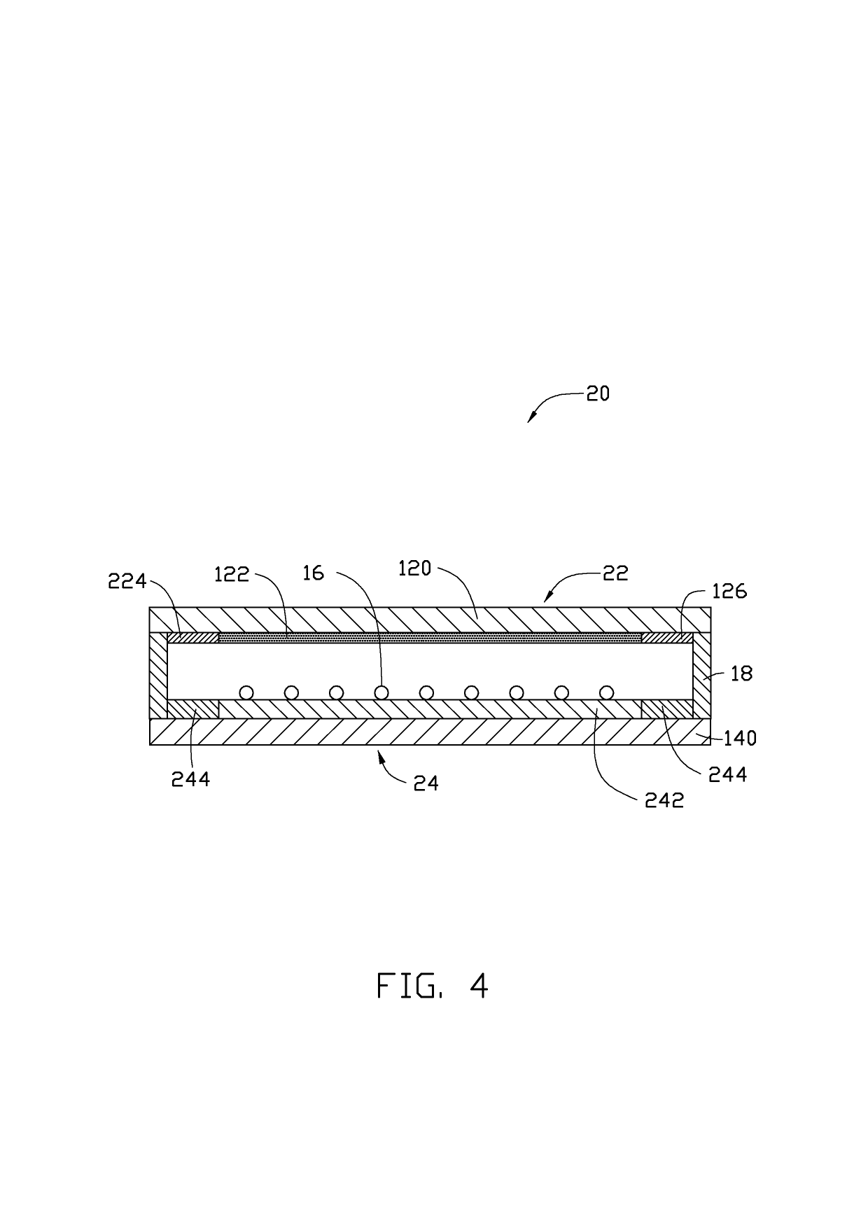

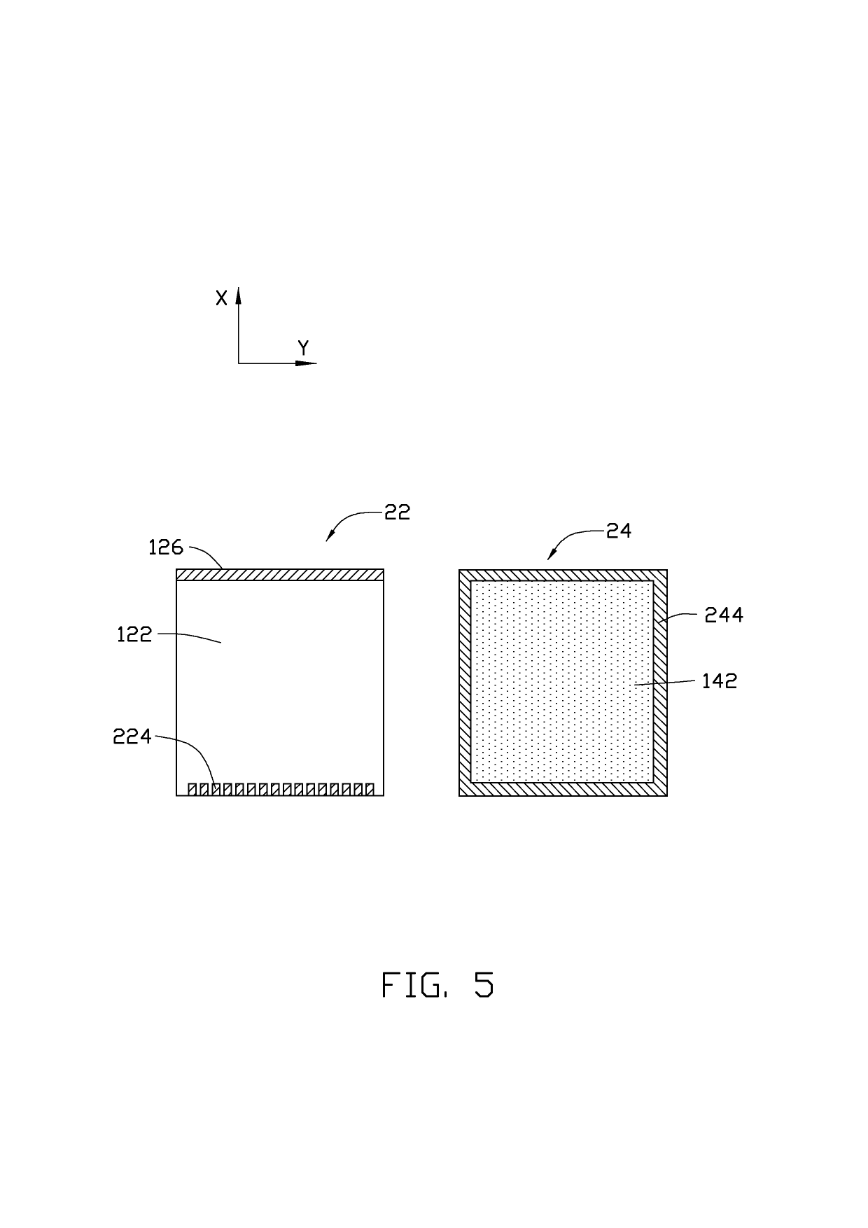

Referring to FIG. 4 and FIG. 5, another embodiment of a touch panel 20 includes a first electrode plate 22, a second electrode plate 24, a plurality of dot spacers 16, and an insulating frame 18.

The touch panel 20 has a similar structure as the touch panel 10, except for the distribution of the electrodes on the first electrode plate 12 and the second electrode plate 14.

The first electrode plate 22 includes a plurality of first electrodes 224 and a second electrode 126. The plurality of first electrodes 224 are located on the same side of the first conductive layer 122 and opposite to the second electrode 126. The plurality of first electrodes 224 are spaced from each other. In other words, the plurality of first electrodes 224 and the second electrode 126 are located on opposite sides of the first conductive layer 122 along the X axis. The first electrodes 224 and the second electrode 126 are electrically connected to the first conductive layer 122. The first conductive layer 122 is a carbon nanotube layer with different conductivity along different directions. The resistivity of the first conductive layer 122 along the X axis is less than the resistivity of the first conductive layer 122 along the Y axis. In one embodiment, the ratio of the resistivity of the first conductive layer 122 along the Y axis and the resistivity of the first conductive layer 122 along the X axis is greater than 10:1. The first conductive layer 122 is divided into a plurality of conductive channels by the plurality of first electrodes 224. The second electrode 126 is bar shaped.

The second electrode plate 24 includes a third electrode 244. The third electrode 244 is continuously located on the periphery of the second conductive layer 142 and extends along the sides of the second conductive layer 142 to form a frame structure. The third electrode 244 is electrically connected to the second conductive layer 124. The third electrode 244 is a continuous metal conductive layer. The second electrode plate 24 only has the third electrode 244 thereon.

The first electrodes 224 and the third electrode can be the same or similar to the first electrode 124 and the second electrode 144. The other structure of the touch panel 20 can be the same or similar to the structure of the touch panel 10.

In operation of the touch panel 20, the third electrode 144 is connected to the ground, and a voltage applied to the second conductive layer 142 is about 0 volts. The second electrode 126 is connected to a stable DC voltage, such as about 10 volts. A voltage applied to the first conductive layer 122 is about 10 volts. Changes in voltage of the first conductive layer 122 are detected by the plurality of first electrode 124 to calculate the position of the deformation.

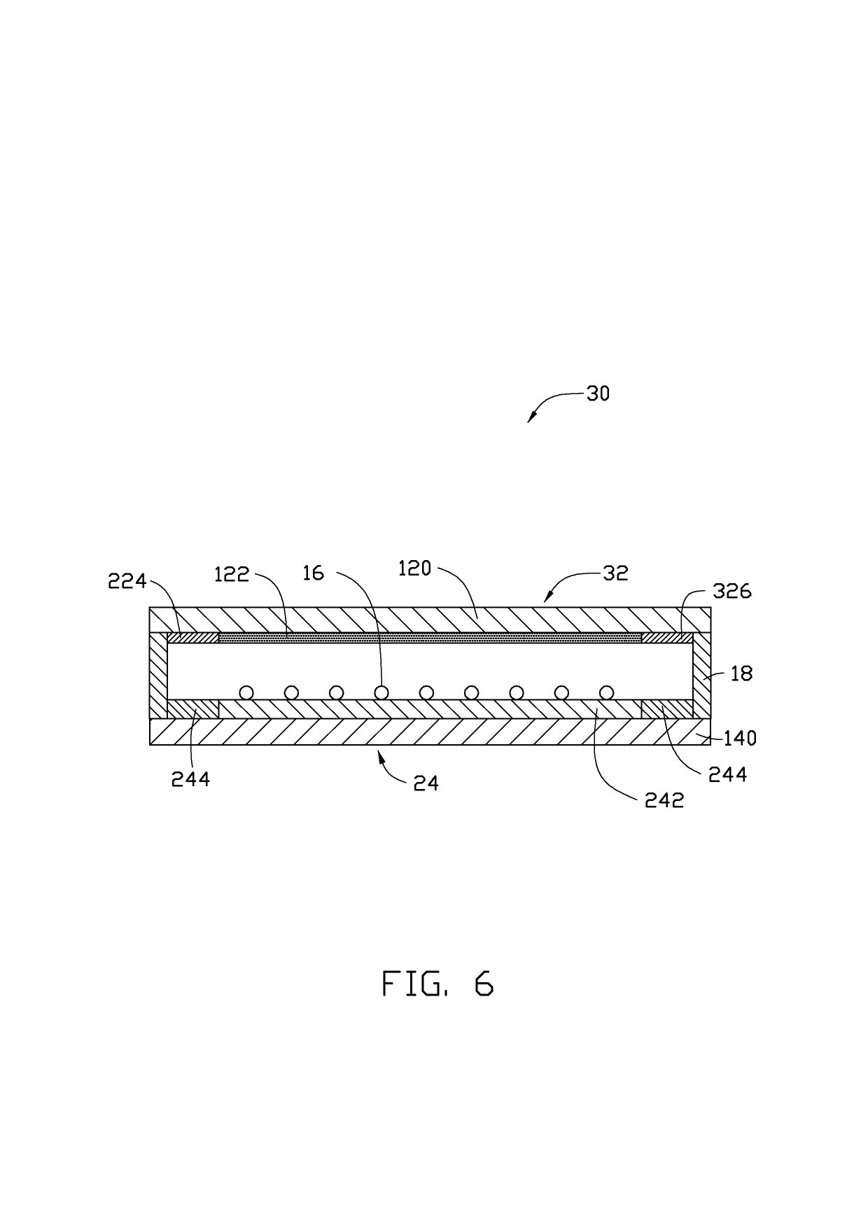

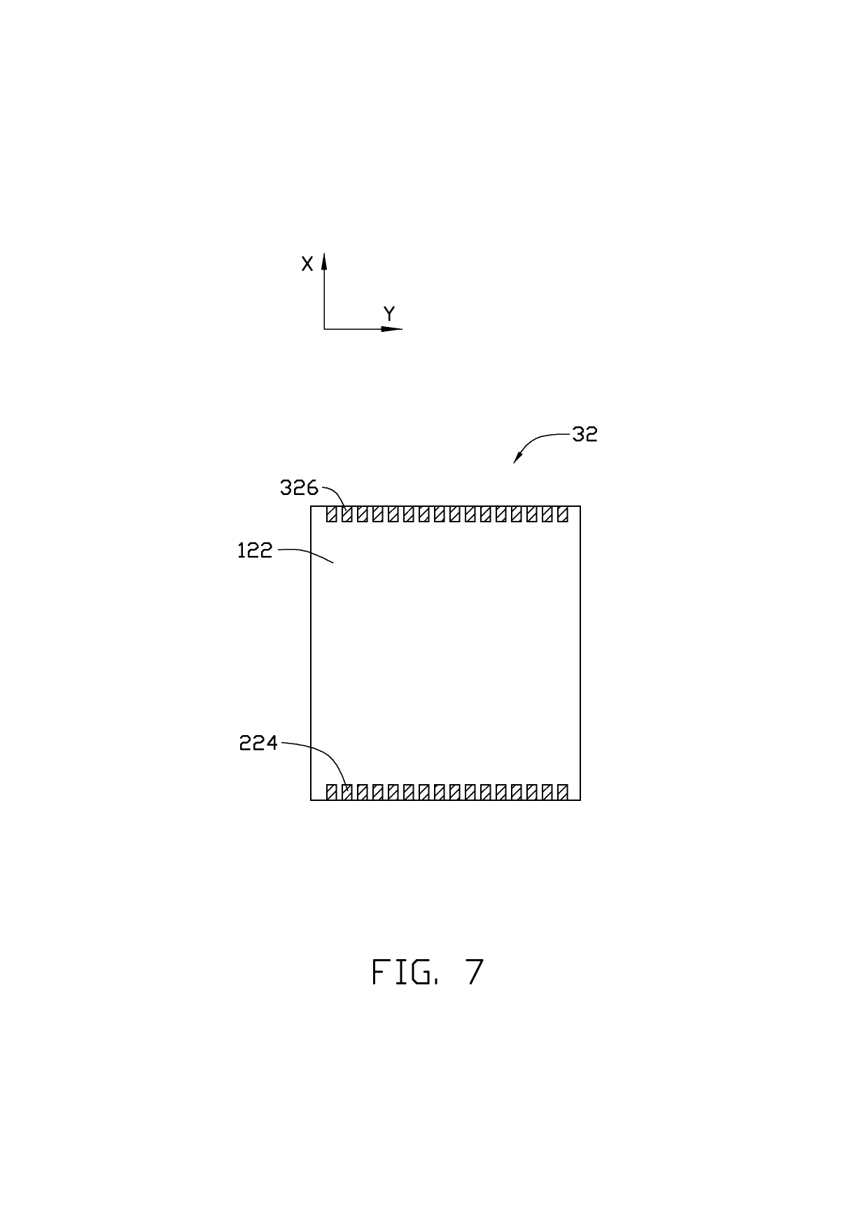

Referring to FIG. 6 and FIG. 7, another embodiment of a touch panel 30 includes a first electrode plate 32, a second electrode plate 24, a plurality of dot spacers 16, and an insulating frame 18.

The touch panel 30 has a similar structure as the touch panel 20, and the difference between the touch panel 30 and the touch panel 20 is that the distribution of the electrodes on the first electrode plate 12. The first electrode plate 32 includes a plurality of first electrodes 224 and a plurality of second electrodes 326. The plurality of first electrodes 224 and the plurality of second electrodes 326 are located on opposite sides of the first conductive layer 122. The plurality of second electrodes 326 are spaced from each other and located along the Y axis.

In operation of the touch panel 30, both the first electrodes 224 and the second electrodes 326 can be used as voltage input electrodes and detection voltage output electrodes. If the first electrode 224 is used as the voltage input electrode, the second electrode 326 is used as the detection voltage output electrode. If the first electrode 224 is used as the detection voltage output electrode, the second electrode 326 is used as the voltage input electrode. In other words, the first electrode 224 and the second electrode 326 are alternately driven in input/output to increase the positioning accuracy of the touch panel 30.

The second electrode plate 24 of the touch panel 20 or the touch panel 30 can be the same as the second electrode plate 14 of the touch panel 10. In other words, the second electrode plate 24 can include two spaced and opposite electrodes located along second direction defined as the Y axis.

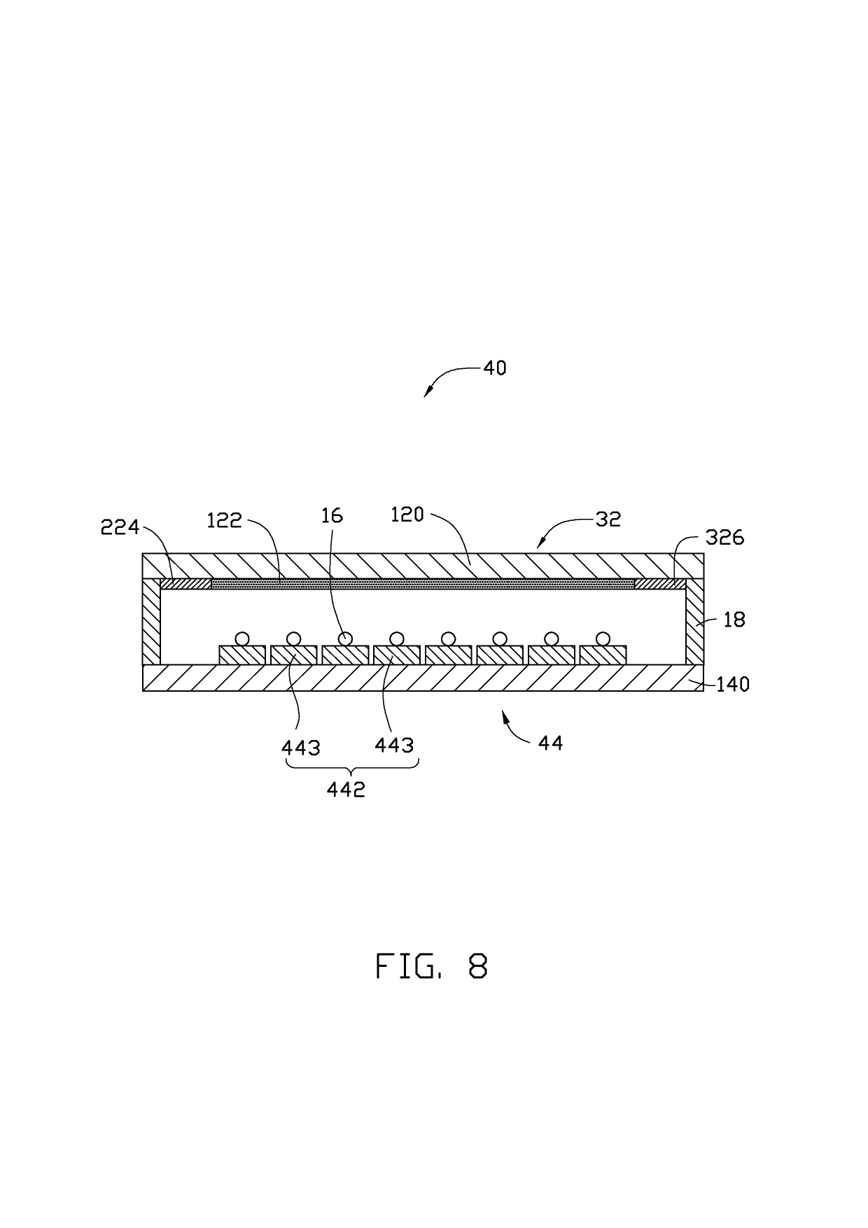

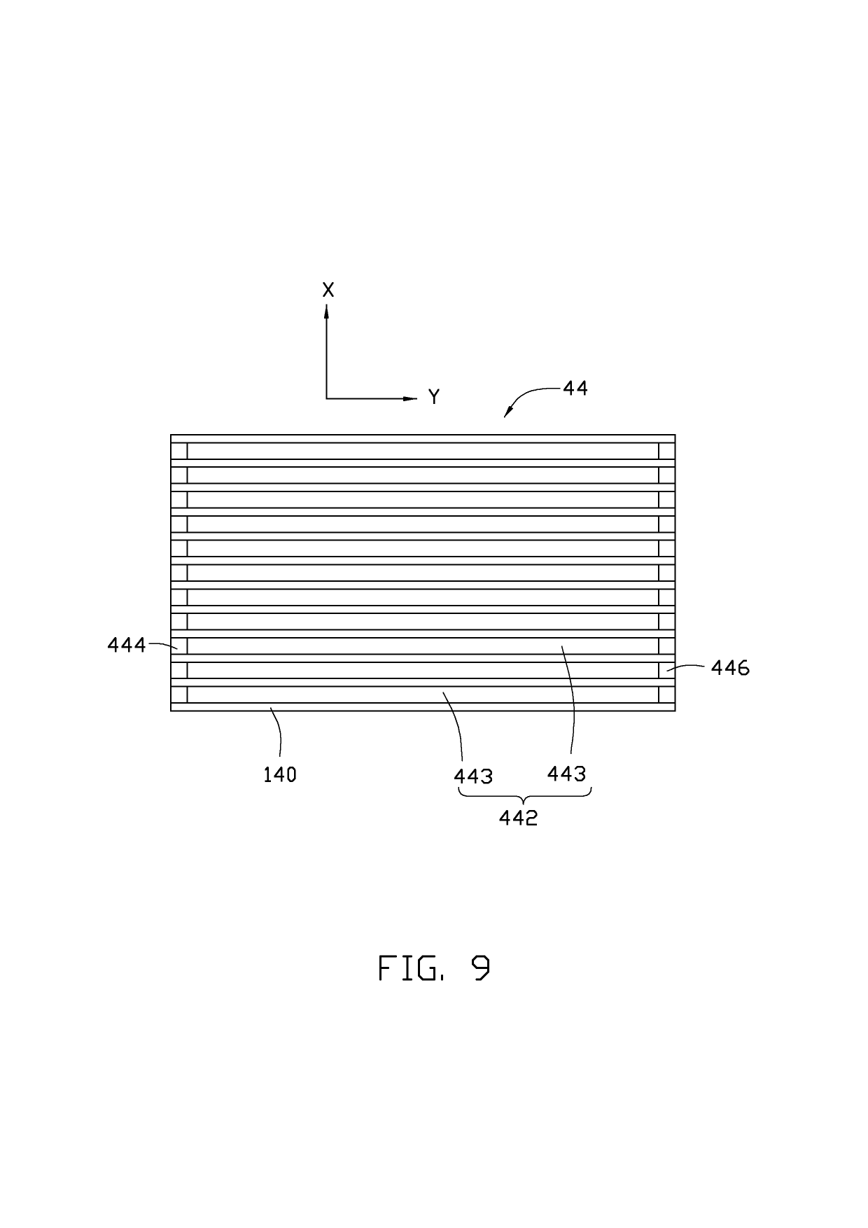

Referring to FIG. 8 and FIG. 9, another embodiment of a touch panel 40 includes a first electrode plate 32, a second electrode plate 44, a plurality of dot spacers 16, and an insulating frame 18.

The second electrode plate 44 includes a second substrate 140, a second conductive layer 442, a plurality of third electrodes 444, and a plurality of fourth electrodes 446. The second conductive layer 442 includes a plurality of metal strips 443. The plurality of metal strips 443 are substantially parallel to each other and located on the second substrate 140. The plurality of metal strips 443 extend substantially along the Y axis. In other words, the extending direction of the metal strips 443 is substantially perpendicular to the extending direction of the carbon nanotubes of the first conductive layer 122. The plurality of third electrodes 444 and the plurality of fourth electrodes 446 are located on opposite sides of the second conductive layer 442 along the Y axis. The plurality of third electrodes 444 and the plurality of fourth electrodes 446 are spaced and located along the X axis. The plurality of third electrodes 444 and the plurality of fourth electrodes 446 are located with a one-to-one correspondence. Each of the plurality of third electrodes 444 or each of the plurality of fourth electrodes 446 is electrically connected to the plurality of metal strips 443.

The material of the metal strip 443 can be the same as the material of the second conductive layer 142 of the touch panel 10. The plurality of metal strip 443 can be formed by forming a continuous metal conductive layer on the second substrate 140 via evaporating or sputtering, and etching the continuous metal conductive layer. In one embodiment, the plurality of metal strips 443 can be formed via printing, spraying, or nano-imprinting. The method of forming the plurality of metal strips 443 is simple.

In operation of the touch panel 40, the third electrode 444 and the fourth electrode 446 are connected to the ground, the first electrode 224 and the second electrode 326 are alternately connected to a high voltage. Changes in voltage of the first conductive layer 122 are detected by the plurality of first electrodes 224 and the plurality of second electrodes 326 to calculate the position of the X axis. Alternatively, the first electrode 224 and the second electrode 326 are connected to the ground, and the third electrode 444 and the fourth electrode 446 can be alternately connected to a high voltage. Changes in voltage of the second conductive layer 442 are detected by the plurality of third electrodes 444 and the plurality of fourth electrodes 446 to calculate the position of the Y axis.

The shape of the second conductive layer 442 can be a diamond diagram or other. The number of the third electrode 444 or the fourth electrode 446 can be selected according to need. For example, the number of the third electrode 444 or the fourth electrode 446 can be one. Each third electrode 444 can be connected electrically to at least two metal strips 443. The first electrode plate 32 of the touch panel 40 can be used instead of the first electrode plate 22 of the touch panel 20.

The touch panel has many advantages. First, the touch panel with the opaque second conductive layer can be applied in opaque equipments, such as a keyboard, remote controller, and tablet. Second, the size and the thickness of the carbon nanotube layer and the second conductive layer made of metal can be easily controlled, thus the cost will be reduced. Third, the second conductive layer can be deposited via spraying or printing to form a pattern, thus the method of making the touch panel is simple. Lastly, the carbon nanotube film and the second conductive layer made of metal have good flexibility. If the first substrate and the second substrate are made of a flexible material, the touch panel can also have good flexibility.

It is to be understood that the described embodiments are intended to illustrate rather than limit the disclosure. Any elements described in accordance with any embodiments is understood that they can be used in addition or substituted in other embodiments. Embodiments can also be used together. Variations may be made to the embodiments without departing from the spirit of the disclosure. The disclosure illustrates but does not restrict the scope of the disclosure.

What is claimed is:

1. A touch panel comprising:
a first electrode plate comprising a first substrate and a first conductive layer located on a surface of the first substrate, wherein the first conductive layer is a carbon nanotube layer; and
a second electrode plate comprising a second substrate and a second conductive layer located on a surface of the second substrate, wherein the second conductive layer is opposite to and spaced from the first conductive layer, and the second conductive layer is a metal conductive layer.

2. The touch panel of claim 1, wherein the carbon nanotube layer comprises a plurality of carbon nanotubes arranged substantially along a first direction.

3. The touch panel of claim 2, wherein the metal conductive layer comprises a plurality of metal strips spaced from and substantially parallel to each other, and each of the plurality of metal strips substantially extends substantially along a second direction substantially perpendicular to the first direction.

4. The touch panel of claim 3, wherein the second electrode plate further comprises a third electrode and a fourth electrode spaced from each other and located on opposite sides of the second conductive layer, and the third electrode and the fourth electrode extend substantially along the first direction.

5. The touch panel of claim 4, wherein the second electrode plate comprises a plurality of third electrodes and a plurality of fourth electrodes, the plurality of third electrodes and the plurality of fourth electrodes are located with a one-to-one correspondence, and each of the plurality of third electrodes or each of the plurality of fourth electrodes is electrically connected to the plurality of metal strips.

6. The touch panel of claim 1, wherein the metal conductive layer comprises a materiel selected from the group consisting of aluminum, silver, copper, iron, cobalt, and nickel.

7. The touch panel of claim 1, wherein a thickness of the metal conductive layer is greater than 10 nanometers.

8. The touch panel of claim 7, wherein the thickness of the metal conductive layer is greater than or equal to 50 nanometers, and less than or equal to 30 micrometers.

9. The touch panel of claim 1, wherein the carbon nanotube layer comprises a carbon nanotube film, a majority of the carbon nanotubes of the carbon nanotube film are oriented along a preferred orientation, and one end of one of the large number of carbon nanotubes is joined to another end of an adjacent one of the large number of carbon nanotubes arranged substantially along the same direction, by van der Waals attractive force.

10. The touch panel of claim 1, wherein the carbon nanotube layer is a freestanding structure and located on the first substrate directly.

11. The touch panel of claim 1, wherein the first electrode plate further comprises a first electrode and a second electrode spaced from each other and located on opposite sides of the first conductive layer, and the first electrode and the second electrode extend substantially along the same direction.

12. The touch panel of claim 1, wherein the first electrode plate further comprises a plurality of first electrodes and a plurality of second electrodes located on opposite sides of the first conductive layer, the first electrode and the second electrode extend substantially along the same direction, the second electrode plate further comprises a third electrode located on the periphery of the second conductive layer, and the third electrode is electrically connected to the second conductive layer.

13. The touch panel of claim 1, wherein the metal conductive layer is formed via spraying, evaporating, sputtering, or printing.

14. A touch panel comprising:
a first electrode plate comprising a first substrate and a first conductive layer located on a surface of the first substrate, wherein the first conductive layer is a carbon nanotube layer comprising a plurality of carbon nanotubes arranged substantially along a first direction; and
a second electrode plate comprising a second substrate and a second conductive layer located on a surface of the second substrate, wherein the second conductive layer is opposite to and spaced from the first conductive layer, and the second conductive layer comprises a plurality of metal strips arranged substantially along a second direction.

15. The touch panel of claim 14, wherein the first direction is substantially perpendicular to the second direction.

16. The touch panel of claim 14, wherein the first substrate and the second substrate are made of a flexible material selected from the group consisting of polycarbonate, polymethyl methacrylate acrylic, polyethylene terephthalate, polyethersulfone, polyvinyl chloride, benzocyclobutenes, polyesters, acrylic resins, acrylonitrile butadiene styrene, polyamide, and combination thereof.
